(19) United States
(12) Patent Application Publication
(10) Pub. No.: US 2013/0141590 A1
(43) Pub. Date: Jun. 6, 2013

(54) Infrared Camera

(71) Applicant: Tamron Co., Ltd., Saitama-shi (JP)

(72) Inventor: Takehiro Matsumoto, Saitama-shi (JP)

(73) Assignee: TAMRON CO., LTD., Saitama-shi (JP)

(21) Appl. No.: 13/693,348

(22) Filed: Dec. 4, 2012

(30) Foreign Application Priority Data
Dec. 5, 2011 (JP) 2011-265546

(51) Int. Cl. H04N 5/33

(52) U.S. Cl. CPC H04N 5/33
USPC 348/164

(57) ABSTRACT

An object of the present invention is to provide an infrared camera capable of shading correction with ease and an improved degree of accuracy and has good maintenance ability. To achieve the object, an infrared camera provided with an infrared lens group and an infrared image sensor located at an image focusing surface of the infrared lens group in a housing in which a window is formed at a portion facing the object side of the infrared lens group comprising: a controller correcting a captured image according to an output from the infrared image sensor and outputting the corrected image; a shutter arranged on an infrared light path in the housing from the window to the infrared lens group; and a temperature sensor detecting the temperature of the shutter is adopted.

### BACKGROUND OF THE INVENTION

1. Field of the Invention

The present invention relates to an infrared camera made proper shading correction enable.

2. Description of the Related Art

An infrared camera is a camera which captures the thermal image data of the object by using infrared lenses made of an infrared-transparent optical material and forming an image of infrared radiation emitted from an object on an image sensor arranged at the image focusing surface of the infrared lenses. In the recent years, a human sensing using such infrared cameras has been widely used in various fields such as security and automobile applications.

However, infrared radiation emitted from other objects such as components of the infrared camera simultaneously enters into an optical system of an infrared camera in addition to infrared radiation emitted from an object. Such infrared radiation emitted from the objects such as components of the infrared camera will cause ill effects on imaging of infrared radiation emitted from the object. Then, shading correction, which is correction to cancel infrared radiation not emitted from objects, has been used in the past.

Japanese Patent No. 3635937 (Patent Document 1) discloses a shading correction technology in which a component having a uniform temperature such as a shutter is provided between an infrared optical system and an infrared image sensor, that is, in the imaging side of the infrared optical system. Then, an image captured when the shutter is closed is stored as an offset image data, the offset data stored is added to or subtracted from an entire image data, and the calculation result is visualized as an image of infrared radiation from an object.

However, the infrared camera disclosed in Patent Document 1 provided with the shutter in the imaging side of the infrared optical system has the following problems. No shading correction in the infrared optical system locates in the object side of the shutter will result a poor image resolution and have been hard to form good images. To form good images in such an infrared camera, image correction by using software which can corrects image with consideration of the infrared optical system which is installed in the controller has been required. However, the correction using the software causes problems not only complex control system but also cost increase because of installation of different software when the infrared optical system is replaced.

Furthermore, for maintenance of the shutter, the infrared optical system and the infrared image sensor should be disassembled from the infrared camera because the shutter is arranged between the infrared optical system and the infrared image sensor. Then, such maintenance will cause problem, readjustments of the optical system will be required because of failure of the optical system caused by improper optical balance.

Further, conventional shading correction using a shutter has been caused another problem that temperature fluctuation in the shutter affects the resolution of images, and it makes formation of good images difficult. Especially when the shutter is arranged at a location close to the infrared image sensor, the shutter tends to be affected by heat generated in the infrared image sensor and cause inconvenience such as an attractive fixed pattern noise in images.

The present invention has been finished to solve the problems in the conventional technologies described above and an object of the present invention is to provide an infrared camera having easy and more accurate shading correction and good maintenance ability.

### SUMMARY OF THE INVENTION

The present inventors have made intensive studies and achieved the object described above by adopting the infrared camera described below.

An infrared camera according to the present invention is the infrared camera provided with an infrared lens group and an infrared image sensor located at an image focusing surface of the infrared lens group in a housing in which a window is formed at a portion facing the object side of the infrared lens group characterized in comprising: a controller which corrects a captured image according to an output from the infrared image sensor and outputs the corrected image; a shutter arranged on an infrared light path in the housing from the window to the infrared lens group; and a temperature sensor which detects the temperature of the shutter.

In the infrared camera according to the present invention, it is preferable that the controller comprises a calculation mean which receives temperature information data of the shutter detected by the temperature sensor and corrects a captured image according to the temperature information data and output data of the infrared image sensor.

In the infrared camera according to the present invention, it is preferable that the shutter is made of a blackbody material.

In the infrared camera according to the present invention, it is preferable that the shutter comprises temperature control means which maintains the shutter temperature at a specific value based on the temperature of the shutter detected by the temperature sensor. More preferably, the temperature control means is a heating means which elevates temperature of the shutter.

In the infrared camera according to the present invention, it is preferable that the space in the housing of the infrared camera is sealed.

In the infrared camera according to the present invention, it is preferable that the shutter is arranged at a location closest to an object side of the infrared lens group.

In the infrared camera according to the present invention, it is preferable that the shutter is arranged at the imaging side of the window.

The infrared camera according to the present invention enables shading correction among the shutter and the infrared lens group because the shutter having a temperature sensor is arranged on the infrared light path in the housing from the window to the infrared lens group unit. Then, highly accurate shading correction based on the temperature of the shutter detected by the temperature sensor makes forming of good image possible.

Further, sealing inside of the housing can reduce temperature fluctuation in the housing because the inside of the housing is protected from the influence of heat from outside. Then, the reduced influence of temperature fluctuations during shading correction makes forming of good image possible.

### BRIEF DESCRIPTION OF THE DRAWINGS

FIG. 1 is a diagram schematically illustrating an internal structure of an infrared camera according to a first embodiment of the present invention;

FIG. 2 is a diagram schematically illustrating an internal structure of an infrared camera according to a second embodiment of the present invention; and

FIG. 3 is a diagram schematically illustrating an internal structure of an infrared camera according to a third embodiment of the present invention.

### DETAILED DESCRIPTION OF THE PREFERRED EMBODIMENTS

An infrared camera according to the present invention is the infrared camera provided with an infrared lens group and an infrared image sensor located at an image focusing surface of the infrared lens group in a housing in which a window is formed at a portion facing the object side of the infrared lens group includes a controller which corrects a captured image according to an output from the infrared image sensor and outputs the corrected image, a shutter arranged on an infrared light path in the housing from the window to the infrared lens group, and a temperature sensor which detects the temperature of the shutter.

Then, preferred embodiments of the infrared camera according to the present invention will be described below with reference to drawings. It should be noted first that the present invention is not limited to the embodiments illustrated.

### First Embodiment

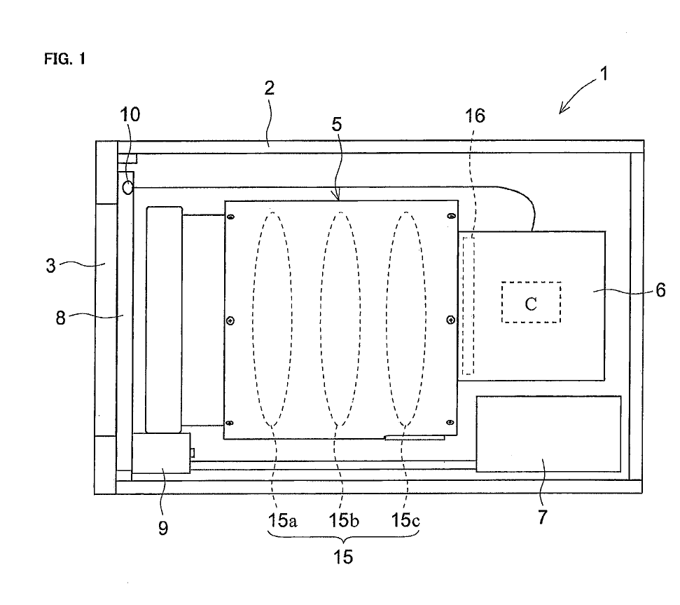

Structure of infrared camera: A structure of an infrared camera according to a first embodiment will be described first with reference to FIG. 1. FIG. 1 is a diagram schematically illustrating an internal structure of the infrared camera according to the first embodiment of the present invention. As shown in FIG. 1, in the infrared camera 1 according to the present invention, components such as an infrared lens unit 5, a camera body 6, a power supply circuit board (power supply) 7 are contained in a housing 2 of the infrared camera 1.

The housing 2 constitutes the outer case of the infrared camera 1. The housing 2 is substantially cylindrical. Further, the space in the housing 2 is sealed. Then, in the object side of the housing 2, the window 3 is formed at a portion facing to the object side of the infrared lens group 15 of the infrared lens unit 5.

The window 3 is made of an infrared-transparent material. As the infrared-transparent material, it is preferable to use germanium. Not only germanium but also any other materials that transmit infrared radiation may be used. For example, the window 3 may be made of a material such as silicon or sapphire, which has a high infrared-transparency.

The infrared lens unit 5 is provided at the object side of the camera body 6. The infrared lens unit 5 is constituted with an infrared lens group 15 including a plurality of infrared lenses 15a to 15c. The infrared lens unit 5 shown in FIG. 1 includes three infrared lenses 15a, 15b and 15c arranged in series on an infrared light path. Note that the number of infrared lenses that constitutes the infrared lens group 15 in the present invention is not limited to three as shown in the structure of FIG. 1. The infrared lens unit 5 may be constituted with two or less infrared lenses or four or more infrared lenses.

The camera body 6 includes the infrared image sensor (infrared detector) 16 and the controller C. The infrared image sensor 16 is arranged at an image focusing surface of the infrared lens group 15. The infrared image sensor 16 in the present embodiment is arranged at a location close to the infrared lens unit 5 in the imaging side of the infrared lens group 15; and the object side of the camera body 6.

The controller C controls operations of the infrared camera 1. The controller C includes calculation mean which outputs a captured image corrected according to temperature information data of the shutter 8 received from a temperature sensor 10, which will be descried later, and an image data of the shutter 8 detected by the infrared image sensor 16 of the camera body 6, i.e. an image data converted from an image formed on the infrared image sensor 16. Further, the controller C also controls operation of a shutter motor 9, which is a shutter driving mechanism that opens and closes the shutter 8 described later.

Then, the shutter 8 will be described. The shutter 8 is arranged for shading correction of images. The shutter 8 is arranged on the infrared light path in the housing 2 from the window 3 to the infrared lens group 15 of the infrared lens unit 5.

In the infrared camera 1 shown in FIG. 1, the shutter 8 is arranged in the imaging side of the window 3 in the housing 2 and close to the window 3. A movable plane of the shutter 8 is opened and closed by driving operation of the shutter motor 9. The movable plane can cover the surface of the infrared lens group 15 in the object side and cover the surface of the window 3 in the imaging side. Further, the movable plane is arranged to extend substantially perpendicular to the infrared light path in the housing. That is, the surface of the movable plane of the shutter 8 in the object side faces the surface of the window 3 in the imaging side and is arranged in the window 3 side of the housing 2 extending substantially parallel to the surface of the window 3 in the imaging side.

The shutter 8 is installed on an inner wall of the housing 2. Any existing method is used for installation of the shutter 8 to the housing 2. For example, a construction where an immovable part that extends substantially parallel to the movable plane may be provided on the outer peripheral rim of the movable plane of the shutter 8 and engage an edge of the immovable part on the sidewall of the housing may be employed. Alternatively, a construction where an attachment that crosses the movable plane of the shutter 8 at right angles may be provided on the outer peripheral rim of the movable plane and an edge of the attachment in the object side may be engaged to the inner wall of the housing 2 at the outer peripheral rim of the window 3. As these methods for installation are just an example; any other method that can arrange the shutter 8 at a specific location in the housing 2 stably may be used.

In the infrared camera shown in FIG. 1, an attachment that crosses the movable plane of the shutter 8 at right angle is provided on the outer peripheral rim of the movable plane and the edge of the attachment in the object side is designed to engage to an engaging part provided on the inner wall of the housing 2 at the outer peripheral rim of the window 3.

The shutter 8 is preferably made of a blackbody material. Note that, the blackbody material theoretically defined is an object that completely absorbs all wave lengths of heat radiation incident on it from the outside and does not emit heat radiation, i.e. the blackbody material is a perfect radiator that has an emissivity of 1. However, the term blackbody material in the present application refers to a material that has a high emissivity close to 1 and entire temperature distribution is uniform. Examples of such a blackbody material having high emissivity include carbon and graphite.

The shutter motor 9 is connected to the shutter 8 and driving operation of the shutter motor 9 opens and closes the shutter 8. The shutter motor 9 is connected to the power supply 7.

The shutter 8 is provided with a temperature sensor 10 that detects temperature of the shutter 8 itself. The temperature sensor 10 is configured to send temperature information data indicating the detected temperature of the shutter 8 to the controller C of the camera body 6. When the controller C receives the temperature information data of the shutter 8 detected by the temperature sensor 10, the calculation mean in the controller C corrects a captured image according to the temperature information data and an output data from the infrared image sensor 16 of the camera body 6. Details in the correction procedure will be described later.

Since the shutter 8 according to the present invention is arranged in the infrared light path in the housing 2 from the window 3 to the infrared lens group 15 of the infrared lens unit 5 as described above, installation of the shutter 8 provided with the temperature sensor is made easy. The structure can reliably prevent wrong matters during installation of the shutter 8 when the shutter 8 is arranged between the infrared lens group 15 of the infrared lens unit 5 and the infrared image sensor 16; for example, the shutter 8 contacts with the infrared lens group 15 and/or the infrared image sensor 16 which are arranged at a location close to the shutter 8, and damages the infrared lens group 15 and/or the infrared image sensor 16; or harming coordination in the optical system to miss the sound optical system. Furthermore, the shutter 8 is maintained without disassembling the infrared lens unit 5 and/or the camera body 6, i.e. maintenance ability is improved.

Moreover, since the shutter 8 according to the present embodiment is arranged in the imaging side of the window 3 in the housing 2, the shutter 8 is installed and maintained without handling of the infrared lens unit 5. Especially when the attachment on the outer peripheral rim of the movable plane of the shutter 8 is engaged to an engaging part provided on the inner wall of the housing 2 at the outer peripheral rim of the window 3 as described above, the shutter 8 is easily and stably installed and removed.

Operation of infrared camera: An operation of the infrared camera 1 having the structure described above will be described below. The controller C of the infrared camera 1 includes the calculation mean described above that performs shading correction to form a clearer image of an object. The shading correction will be described in detail. In addition to infrared radiation emitted from an object, infrared radiation emitted from components of the camera including the infrared lens group 15 and the housing 2 incidents at the same time on the infrared image sensor 16 of the infrared camera 1. The influence of infrared radiation from the components such including infrared lens group 15 and the housing 2 are commonly known as shading. The amount of shading is not constant and the influence varies according to the temperatures condition of the camera. In the conventional shading correction for cancelling infrared radiation from the components of the infrared camera 1, the shutter 8 that is an object having a uniform temperature distribution is provided between the window 3 and the infrared lens group 15 of the infrared lens unit 5 on the infrared light path in the housing 2, an image captured when the shutter 8 is closed is stored as an offset image data, and the offset image data stored is added to or subtracted from an image data at the common pixel of the infrared imaging sensor 16 captured when the shutter 8 is opened and an image of infrared radiation from the object is formed.

The controller C of the infrared camera 1 according to the present embodiment includes calculation mean that receives temperature information data of the shutter 8 detected by the temperature sensor 10 and performs shading correction based on the temperature information data, in addition to the conventional shading correction based on an output from the infrared image sensor 16. That is, the controller C of the infrared camera 1 according to the present embodiment corrects a captured image according to temperature information data of the shutter 8 detected by the temperature sensor 10 and an output data from the infrared image sensor 16. The detail operation will be described below.

First, the controller C of the camera body 6 operates the shutter motor 9 to close the shutter 8. The controller C then converts an image formed on the infrared image sensor 16 of the camera body 6 to an infrared image data and stores the data in a memory (hereinafter referred to as the first memory). The image data stored in the first memory is an infrared image of the surface of the shutter 8. At the same time, the controller C receives temperature information data of the shutter 8 sent from the temperature sensor 10 and stores the temperature information data in another memory (hereinafter referred to as the second memory). After finishing the data storage in the first memory and the second memory, the controller C of the camera body 6 operates the shutter motor 9 to open the shutter 8. Then, acquisition of an offset image data finishes.

After opening the shutter 8 as described above, the controller C captures an image (an image of the object) formed on the infrared image sensor 16 arranged at the image focusing surface of the infrared lens group 15 as an infrared image data. At this point in time, the controller C receives temperature information data of the shutter 8 now from the temperature sensor 10 and compares the received temperature information data of the shutter 8 with the temperature information data stored in the second memory. If the two temperature information data is equal, the controller C judges that calculation including temperature information data now is not necessary. Then, the calculation mean of the controller C performs conventional calculation of adding or subtracting the temperature information data of the shutter 8 stored in the first memory described above to or from the infrared image data converted. As a result, the infrared image data is converted to a data based on a uniform image based on the surface of the shutter 8. The data converted from the infrared image data is output as a converted analog video data.

On the other hand, if the comparison between the temperature information data of the shutter 8 now received from the temperature sensor 10 and the temperature information data stored in the second memory shows that the temperature information data are different, the controller C judges that computation that includes temperature difference in calculation is necessary. It is because, as the temperature in the housing 2 of the infrared camera 1 fluctuates and the temperature of the shutter 8 fluctuates accordingly, the bolometer resistance of each pixel changes. Consequently, even if infrared radiation from the object is the same, the fluctuation in temperature appears as a difference in an image data and it affects the resolution of the image. So, if temperature information data of the shutter 8 now received from the temperature sensor 10 of the shutter 8 differs from temperature information data stored in the second memory in the infrared camera 1 according to the present invention, the controller C of the camera body 6 calculates the amount of the temperature difference by the calculation mean of the controller C itself. Then, when adding or subtracting the data stored in the first memory to or from the infrared image data obtained, a calculation in the controller C will include the calculated amount of temperature difference, and outputs calculation result as a converted analog video data. In this way, the captured image is corrected in accordance with the temperature fluctuation of the shutter 8. Consequently, a good image is obtained consistently even when the temperature in the housing 2 (the temperature of the shutter 8) fluctuates.

Note that the controller C in the present invention may be any controller that uses calculation mean to correct a captured image according to temperature information data of the shutter detected by the temperature sensor and an output from the infrared image sensor 16. Therefore, the infrared camera according to the present invention is not limited to one in which when temperature information data of the shutter 8 now received from the temperature sensor 10 of the shutter 8 differs from temperature information data stored in the second memory, a calculation in the controller C will include the amount of calculated temperature difference, and outputs converted analog video data.

For example, if temperature information data of the shutter 8 now received from the temperature sensor 10 of the shutter 8 is different from temperature information data stored in the second memory, the controller C may operate the shutter motor 9 to close the shutter 8 again to acquire a new offset image data.

As has been described above, in the infrared camera 1 according to the present invention, the temperature sensor 10 which detects temperatures of the shutter 8 is provided for the shutter 8 arranged on the infrared light path in the housing 2 from the window 3 to the infrared lens group 15 of the infrared lens unit 5 and temperature information data from the temperature sensor 10 is used in shading correction. Accordingly, shading correction with a high degree of accuracy is performed and a good image is obtained.

Especially in a structure where the shutter 8 is provided between the window 3 and the infrared lens group 15, that is, at a location close to the window 3 as in the present invention, a temperature of the shutter 8 may be affected by fluctuations in the environment outside the housing 2. However, sealing the housing 2 substantially isolates the components inside the housing 2 from the influence of the outside atmosphere and fluctuations in the temperature of the shutter 8 is restricted. Further, the sealing can also restrict fluctuations of the temperature in the housing 2. Consequently, reduction in the influence of temperature fluctuations during shading correction achieves good imaging.

Note that although the shutter 8 is arranged in the imaging side of the window 3 in the infrared camera described in the first embodiment as shown in FIG. 1, the location of the shutter 8 in the present invention is not limited to the imaging side of the window 3 shown in FIG. 1. The shutter 8 in the present invention may be arranged in any location on the infrared light path in the housing 2 from the window 3 to the infrared lens group 15. A mode in which the shutter is arranged in a location different from the location in the present embodiment will be described below.

### Second Embodiment

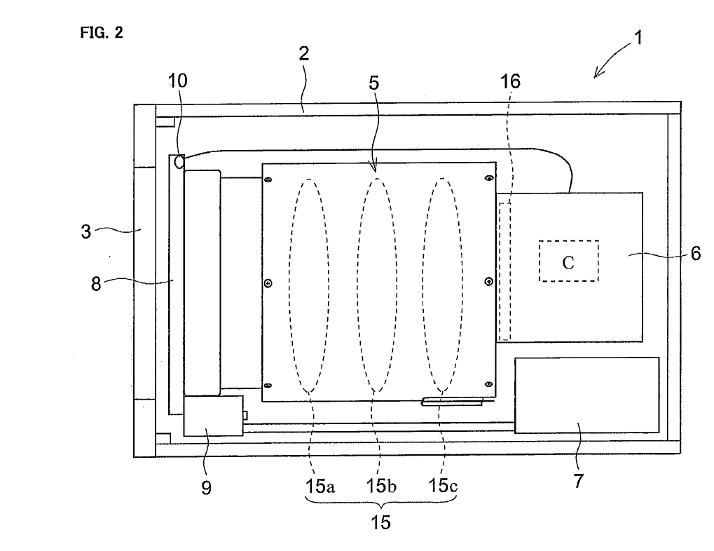

FIG. 2 schematically illustrates an infrared camera according to a second embodiment. The infrared camera 1 according to the second embodiment has a shutter 8 arranged closest to the object side of an infrared lens group 15. In the infrared camera 1 according to the present embodiment, the shutter 8 is arranged in a location in the object side of the infrared lens 15a and closest to the infrared lens 15a of the infrared lens group 15 as shown in FIG. 2.

Note that difference in FIG. 2 form the first embodiment is just the location of the shutter 8, and the structure and operation are the same with the first embodiment. Therefore, description of the same components and operation as those in the first embodiment will be omitted.

The shutter 8 shown in FIG. 2 may be attached on an infrared lens unit 5, instead of being attached to the inner wall of the housing 2 as in the infrared camera 1 of the first embodiment described above. Specifically, an attachment that extends in the direction that crosses the movable plane of the shutter 8 at substantially right angles may be provided on the outer peripheral rim of the movable plane and an inner peripheral wall of the attachment may be fit into and removed from the outer peripheral surface of the sidewall of the infrared lens unit 5.

As described above, as the attachment that extends to cross the movable plane of the shutter 8 at substantially right angles on the outer peripheral rim of the movable plane is provided and the inner wall of the attachment has construction in which the attachment is fit on into and removed from the outer surface of the sidewall of the infrared lens unit 5, the shutter 8 is attached stably without providing attachments for installation of the shutter 8 on other locations.

### Third Embodiment

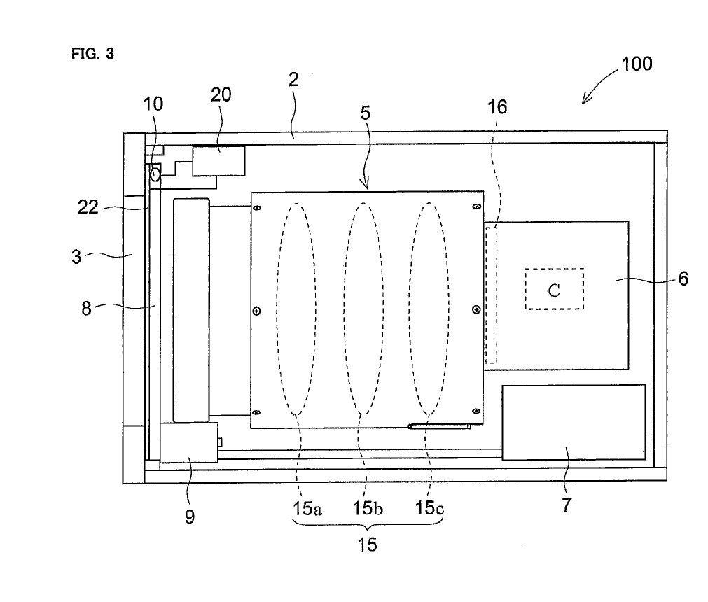

An infrared camera according to a third embodiment will be described next with reference to FIG. 3. The components labeled with signs the same as components of the infrared camera 1 of the first embodiment have effects or functions that are the same as or similar to those components and therefore description on those components will be omitted here.

Structure of infrared camera: A structure of the infrared camera of the third embodiment will be described first. As shown in FIG. 3, the infrared camera 100 according to the present invention includes components such as an infrared lens unit 5, a camera body 6, and a power supply circuit board 7, all of which are contained in a housing 2 of the infrared camera 100. Inside of the housing 2 which constitutes the outer case of the infrared camera 100 is a sealed space.

The camera body 6 includes a controller C that controls operations of the infrared camera 100. The controller C has the function of correcting a captured image according to an output data from an infrared image sensor 16 (that is, output of an image data converted from an image formed on the infrared image sensor 16) and outputting the corrected image. Further, the controller C controls operation of a shutter motor which is a shutter driving mechanism that opens and closes the shutter 8 described later. Note that, the controller C of the present embodiment does not have the function of receiving temperature information data detected by a temperature sensor 10 and does not have calculation mean for correcting a captured image according to temperature information data that the controller C of the first embodiment have.

The shutter 8 will be described below. The shutter 8 is provided to correct the resolution of an image (shading correction) as in the first embodiment. The shutter 8 is arranged on the infrared light path in a housing 2 from a window 3 to an infrared lens group 15 of an infrared lens unit 5. The shutter 8 has an attachment that crosses a moving surface of the shutter at substantially right angles and provided on an outer peripheral rim of the movable plane and an edge of the attachment in the object side may be engage to an engaging part provided on an inner wall of the housing 2 at the outer periphery of the window 3. Note that the installation way of the shutter 8 is not limited to the engagement and any existing method is used to install the shutter 8 as same as the shutter 8 described in the first embodiment. The installation location of the shutter 8 is not limited to the location shown in FIG. 3. For example, the shutter 8 may be arranged at a location close to the infrared lens group 15 in the side of the infrared lens group 15 that is closest to the object side as described in the second embodiment.

The shutter 8 includes temperature control means for maintaining the shutter 8 at a specific temperature according to the temperature of the shutter 8 detected by a temperature sensor 10: The temperature control means includes a temperature controller 20 and heating means for heating the shutter 8. The heating means may be any means that can uniformly heat the entire shutter 8. Examples of the heating mean include a heating sheet, a heating panel, and a heater. The heating means used in the present embodiment is a heating sheet 22.

The heating sheet 22 may be bonded to one entire surface of the shutter 8 or may be bonded around the entire outer peripheral rim of the movable plane, or may be otherwise provided. The shutter 8 may be made of carbon, a synthetic resin, or a metal such as aluminum. Especially in the present embodiment, the shutter 8 is preferably made of a metal that has a high thermal conductivity because the shutter 8 should be maintained at a specific temperature by the temperature control means provided in the present embodiment.

The temperature controller 20 controls the heating calories by the heat sheet 22 to maintain the temperature of the shutter 8, which is detected by the temperature sensor 10, at a specific value, for example +40° C.

Operation of Infrared Camera: An operation of the infrared camera 100 having the structure described above will be described below. At the time power-on the infrared camera 100 of the present embodiment, the temperature controller 20 starts controlling the heating by the heat sheet 22. As a result, the shutter 8 is kept at a specific temperature (+40° C. in the present embodiment). Temperature control of the shutter 8 by the temperature controller 20 is continued until powered off the infrared camera 100.

On the other hand, the controller C of the camera body 6 operates the shutter motor 9 to close the shutter 8. The controller C then converts an image formed on the infrared image sensor 16 to an infrared image data and stores the data in the first memory. The image data stored in the first memory is an infrared image at the surface of the shutter 8. After finishing the storage in the first memory, the controller C of the camera body 6 operates the shutter motor 9 to open the shutter 8. Then, acquisition of an offset image finishes.

Next, with the shutter 8 opening as described above, the controller C converts an image (an image of the object) formed on the infrared image sensor 16 provided at the image focusing surface of the infrared lens group 15 to an infrared image data and adds or subtracts the data stored in the first memory described above to or from the infrared image data. Then, the infrared image data is converted based on a uniform image of the surface of the shutter 8, and is output as a converted analog video data.

As described above, since the shutter 8 of the infrared camera 100 according to the present embodiment is kept at a specific temperature by the temperature control means, the temperature of the shutter 8 does not fluctuate. That is, shading correction is performed without taking into account fluctuations in the temperature of the shutter 8. Consequently, good images are consistently obtained without consideration of fluctuations in the temperature of the shutter 8.

Especially in the infrared camera 100 according to the present embodiment, temperature is controlled without connecting the temperature sensor 10 to the controller C of the camera body 6 and the controller C does not calculate based on temperature information data from the temperature sensor 10. Accordingly, the control mechanism of the controller C is made simple.

As has been describe above, an infrared camera according to the present invention is used as an infrared human sensor. In particular, the infrared camera according to the present invention is beneficially used as a vehicle infrared camera and a surveillance camera for security purposes because the infrared camera enables accurate object recognition.

What is claimed is:

1. An infrared camera provided with an infrared lens group and an infrared image sensor located at an image focusing surface of the infrared lens group in a housing in which a window is formed at a portion facing the object side of the infrared lens group comprising:
a controller which corrects a captured image according to an output from the infrared image sensor and outputs the corrected image;
a shutter arranged on an infrared light path in the housing from the window to the infrared lens group; and
a temperature sensor which detects the temperature of the shutter.

2. The infrared camera according to claim 1, wherein the controller comprises a calculation mean which receives temperature information data of the shutter detected by the temperature sensor and corrects a captured image according to the temperature information data and output data of the infrared image sensor.

3. The infrared camera according to claim 1, wherein the shutter is made of a blackbody material.

4. The infrared camera according to claim 1, wherein the shutter comprises temperature control means which maintains the shutter temperature at a specific value based on the temperature of the shutter detected by the temperature sensor.

5. The infrared camera according to claim 4, wherein the temperature control means is a heating means for heating the shutter.

6. The infrared camera according to claim 1, wherein the space in the housing is sealed.

7. The infrared camera according to claim 1, wherein the shutter is arranged at a location closest to an object side of the infrared lens group.

8. The infrared camera according to claim 1, wherein the shutter is arranged at the imaging side of the window.
